(19) United States
(12) Patent Application Publication
(10) Pub. No.: US 2009/0042079 A1
(43) Pub. Date: Feb. 12, 2009

(54) CATALYST FOR FUEL CELLS

(76) Inventors: Shuichi Suzuki, Hitachi (JP); Yoshiki Obu, Hitachi (JP); Yoshiyuki Takamori, Hitachinaka (JP); Hiroshi Yamauchi, Hitachi (JP); Yasuo Yoshii, Naka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/018,436

(22) Filed: Jan. 23, 2008

(30) Foreign Application Priority Data
Mar. 29, 2007 (JP) 2007-086322

(51) Int. Cl. H01M 8/10; H01M 4/92

(52) U.S. Cl. 429/33; 429/40; 429/44

(57) ABSTRACT

To provide a catalyst for a fuel cell that has a high oxygen reduction activity and is manufactured at low cost and a fuel cell that has a high power generation efficiency and is manufactured at low cost. As a catalyst for a fuel cell that reduces an oxidizing gas, a catalyst for a fuel cell that contains palladium at least partially oxidized is used. In a fuel cell having an anode that oxidizes a fuel, a cathode that reduces an oxidizing gas and a solid polymer electrolyte membrane disposed between the anode and the cathode, a palladium oxide is used as a cathode catalyst.

### BACKGROUND OF THE INVENTION

1. Field of the Invention

The present invention relates to a catalyst for a fuel cell. In particular, it relates to a catalyst for a fuel cell that is used in a cathode.

2. Background Art

With the recent advance of electronic technology, portable electric equipment, such as cellular phones, notebook personal computers, audio/visual equipment, camcorders and personal digital assistants, have rapidly become popular.

Such conventional portable electric equipment is a system driven by a secondary battery. New secondary batteries with higher energy densities, such as the sealed lead-acid battery, the Ni/Cd battery, the Ni/hydrogen battery and the Li-ion secondary battery, have been developed, and the portable electric equipment has been reduced in size and weight and enhanced in functionality.

For any secondary battery, battery active materials and high capacity battery structures are being developed to achieve higher energy density, and efforts are being made to increase the operating time per charge.

However, the secondary battery always has to be charged after a certain amount of electric power is used and requires charging equipment and a relatively long charging time. Thus, there remain many problems to be solved to allow the secondary battery to continuously drive the portable electric equipment for a long time anywhere at any time.

The portable electric equipment will handle an increasing amount of information and be increased in speed and enhanced in functionality in the future. Thus, there are increasing demands for a power supply with higher power density and higher energy density, that is, a power supply with a longer continuous operating time, and for a micro power generator that requires no charging and can be easily supplied with fuel.

Fuel cells can meet such demands. The fuel cell is a power generator that is composed at least of a solid or liquid electrolyte and two electrodes that induce a desired electrochemical reaction, that is, an anode and a cathode, and converts the chemical energy of the fuel directly into the electric energy with high efficiency.

Examples of the fuel of the fuel cell include hydrogen chemically converted from a fossil fuel or water, methanol, alkali hydride and hydrazine, which are liquid or solution in the normal environment, and dimethyl ether, which is pressure liquefied gas. Examples of the oxidizing gas include air and oxygen gas.

In the fuel cell, the fuel is electrochemically oxidized on the anode, the oxidizing gas is reduced on the cathode, and an electric potential difference occurs between the electrodes. In this state, if a load, which is an external circuit, is connected between the electrodes, ions in the electrolyte are moved, and an electric energy is produced.

Thus, various kinds of fuel cells are considered to be promising as a power supply of the portable electric equipment, as a power supply of a large-scale power generating system to alternate the thermal power generating system, as a power supply of a small distributed cogeneration system, and as a power supply of an electric automobile to alternate the automobile engine generator, and are being actively developed for practical use.

In general, the fuel cell uses platinum or platinum ruthenium as a catalyst in the anode and platinum as a catalyst in the cathode (see patent literatures 1 and 2).

Patent literature 1: JP Patent Publication (Kokai) No. 2006-339120

Patent literature 2: JP Patent Publication (Kokai) No. 2006-331718

### SUMMARY OF THE INVENTION

The platinum catalyst conventionally used cannot achieve an adequate oxygen reduction activity on the cathode, so that the power generation efficiency of the fuel cell is low. In addition, platinum is expensive, so that the catalyst is costly.

Thus, an object of the present invention is to provide a catalyst for a fuel cell that allows a high power generation efficiency to be achieved and alternate a platinum catalyst.

According to an implementation of the present invention, there is provided a catalyst for a fuel cell that reduces an oxidizing gas, in which the catalyst contains palladium, and the palladium is at least partially oxidized.

Preferably, at least 50% or higher of the palladium is oxidized, and more preferably, at least 70% or higher of the palladium is oxidized.

Preferably, the palladium is carbon-supported.

According to an implementation of the present invention, there is provided a fuel cell that has an anode for oxidizing a fuel, a cathode for reducing an oxidizing gas, and a solid polymer electrolyte membrane disposed between the anode and the cathode, in which the cathode contains palladium, and the palladium is at least partially oxidized.

An implementation of the present invention concerns a catalyst for a fuel cell that is used in a cathode, which reduces oxygen in the air, for example, and contains palladium as a primary constituent, and the palladium is oxidized.

The present invention provides a catalyst for a fuel cell that allows an efficient power generation to alternate a platinum catalyst.

### BRIEF DESCRIPTION OF THE DRAWINGS

FIG. 1 is a graph showing a result of XPS analysis of catalysts according to an embodiment of the present invention;

FIG. 2 is a graph showing the oxygen reduction activity of catalysts according to the embodiment of the present invention;

FIG. 3 is a graph showing a relationship between the ratio of palladium oxide and the oxygen reduction activity according to the embodiment of the present invention;

FIG. 4 is a schematic cross-sectional view of a fuel cell according to the present invention; and

FIG. 5 is a cross-sectional view of a portable information terminal according to the present invention.

### DETAILED DESCRIPTION OF THE PREFERRED EMBODIMENTS

Examples of the present invention will be described below.

### Example 1

A catalyst for a fuel cell according to Example 1 is palladium at least partially oxidized.

Compared with conventional platinum catalyst and palladium catalyst, the oxygen reduction activity is improved.

The phrase “palladium at least partially oxidized” used in this example means palladium containing, at least as part thereof, a palladium oxide, such as palladium hydroxide (Pd(OH)2), palladium monoxide (PdO) and palladium dioxide (PdO2).

The palladium at least partially oxidized can contain a composite of these palladium oxides.

As the ratio of the palladium oxide to the metal palladium increases, the oxygen reduction activity becomes higher.

The ratio of the palladium oxide can be evaluated from the bonding energy of electrons in the 3d orbital of palladium measured by X-ray photoelectron spectroscopy (XPS) analysis.

The spectrum intensity of the metal palladium (Pd) has a peak at a bonding energy of 335.0 to 335.5 eV, and the peak shifts to higher bonding energies as the oxidation proceeds.

For example, the spectrum intensity of palladium monoxide (PdO) has a peak at around 336.3 eV, and palladium dioxide (PdO2) has a peak at around 337.9 eV.

Therefore, the degree of oxidation of palladium can be quantitatively evaluated by separating peaks in the spectra of the electrons in the 3d orbital of palladium measured by XPS analysis and comparing the separate peaks.

According to this example, the ratio of the palladium oxide is determined by subtracting the ratio of the metal palladium from 100%, supposing that an integrated value of all peaks derived from the metal palladium/palladium oxide in each catalysts measured by the XPS spectrum analysis is 100%. Peaks of palladium oxides appear at higher energies than the peak of the metal palladium.

The degree of oxidation of the palladium at least partially oxidized used in this example is preferably 50% or higher and more preferably 70% or higher. If the degree of oxidation is lower than 50%, the oxygen reduction activity is low, and a fuel cell to which the catalyst is applied can hardly achieve a practical power density.

The palladium at least partially oxidized preferably is in the form of fine particles. This is intended to increase the surface area per unit weight and achieve a high oxygen reduction activity with a small amount of palladium.

The diameter of the particles preferably is equal to or less than 200 nm, in order to ensure a practical surface area.

The catalyst for a fuel cell according to this example is made effective by the palladium at least partially oxidized. Although the catalyst can contain platinum, ruthenium, manganese, iron, cobalt, nickel, rhodium, rhenium, iridium, gold or tungsten, the catalyst desirably contains 50% or more of palladium. In other words, the primary constituent of the catalyst is the palladium at least partially oxidized.

The method of preparing particles of the palladium at least partially oxidized is not limited to any particular one. For example, oxidation treatment of palladium particles can be used.

Palladium particles can be prepared by electroless deposition, for example.

A reducing agent is added to a solution of a palladium salt, and the temperature of the solution is raised while agitating the solution. Then, the palladium salt is reduced into palladium particles.

Examples of the palladium salt include palladium chloride and palladium nitrate. Examples of the reducing agent include hypophosphorous acid, dimethylamine borane, sodium borohydride, hydrazine and formaldehyde.

The resulting palladium particles can be oxidized by a thermal treatment in an oxygenated atmosphere.

The oxygen concentration of the oxygenated atmosphere can be about 20%, which is equal to the oxygen concentration of the atmosphere. However, as the oxygen concentration becomes higher, the oxidation proceeds more rapidly.

The temperature of the thermal treatment can be about 100 to 600 degrees C. If the temperature is lower than 100 degrees C., the time required to complete adequate oxidation is undesirably too long. If the temperature is higher than 600 degrees C., the resulting palladium oxide particles become large, and the surface area per unit weight undesirably decreases.

Alternatively, an alkali substance is added to a solution of a palladium salt while agitating the solution, thereby depositing palladium oxide particles. The alkali substance can be sodium hydroxide, potassium hydroxide, ammonia or sodium carbonate, for example.

The deposited palladium oxide particles can be turned into powder by filtering and drying, and the atmosphere for the drying is an oxidizing atmosphere or an inert atmosphere. This is intended to prevent the resulting palladium oxide from being reduced into metal palladium.

In this example, palladium available from Soekawa Chemical Co., Ltd. (referred to sometimes as palladium black) is thermally treated in the atmosphere to form a palladium oxide, and the palladium oxide is used as a catalyst. The thermal treatment is carried out at a temperature of 200 degrees C. for duration of 67 hours.

Furthermore, if the palladium at least partially oxidized is supported to a carbon support, the palladium at least partially oxidized can be made finer. Therefore, the surface area per unit weight increases, and the oxygen reduction activity increases.

The carbon support is not limited to any particular one, and the carbon black, which is commonly used, can be used. The specific surface area of the carbon black is preferably about 10 to 1000 m2/g.

If the specific surface area is smaller than 10 m2/g, the distance between the palladium particles is too small, so that the palladium particles aggregate to form larger particles.

If the specific surface area is larger than 1000 m2/g, the pore volume is too high, so that the palladium particles which got into the pores cannot contribute to the reaction, and therefore, the reaction efficiency decreases.

As an alternative of the carbon black, a carbon nanotube can also be used as a carbon support.

The method of having the carbon-supported palladium at least partially oxidized is not limited to any particular one. For example, the carbon-supported palladium can be oxidized.

The oxidation can be carried out under the same conditions as described above.

Furthermore, the carbon-supported palladium can be prepared by electroless deposition as in the preparation of palladium particles.

Specifically, the carbon-supported palladium can be prepared by dispersing a carbon support into a solution of a palladium salt, adding a reducing agent to the solution, and raising the temperature of the solution while agitating the solution.

Alternatively, a carbon support can be dispersed into a solution of a palladium salt, and an alkali substance can be added to the solution while agitating the solution. In this case, palladium oxide particles can be deposited to be carbon-supported.

The resulting catalyst can be turned into powder by filtering and drying, and the atmosphere for the drying is desirably an oxidizing atmosphere or an inert atmosphere, as described above.

Alternatively, a carbon support can be impregnated with as much a solution of a palladium salt as the carbon support powder can retain, and the carbon support impregnated with the solution can be dried in the atmosphere or under reduced pressure and subjected to a thermal treatment in an oxygenated atmosphere. In this case, the palladium salt can be turned into palladium at least partially oxidized, and at the same time, the palladium at least partially oxidized can be supported to the carbon support.

The oxygen concentration of the oxygenated atmosphere can be about 20%, which is equal to the oxygen concentration of the atmosphere. However, as the oxygen concentration becomes higher, the oxidation proceeds more rapidly.

The temperature of the thermal treatment can be about 100 to 600 degrees C. If the temperature is lower than 100 degrees C., the time required to complete adequate oxidation is undesirably too long. If the temperature is higher than 600 degrees C., the resulting palladium oxide particles become large, and the surface area per unit weight undesirably decreases.

### Example 2

Palladium available from Soekawa Chemical Co., Ltd. is thermally treated in the atmosphere at a temperature of 200 degrees C. for four hours to form a palladium oxide, and the palladium oxide is used as a catalyst. The other respects are the same as those in Example 1.

### Comparison Example 1

Palladium available from Soekawa Chemical Co., Ltd. is used as a catalyst. This Comparison Example 1 differs from Example 1 in that the thermal treatment in the atmosphere is not carried out. The other respects are the same as those in Example 1.

### Comparison Example 2

Platinum available from Tanaka Kikinzoku Kogyo K.K. is used as a catalyst. The other respects are the same as those in Example 1.

### (Evaluation 1)

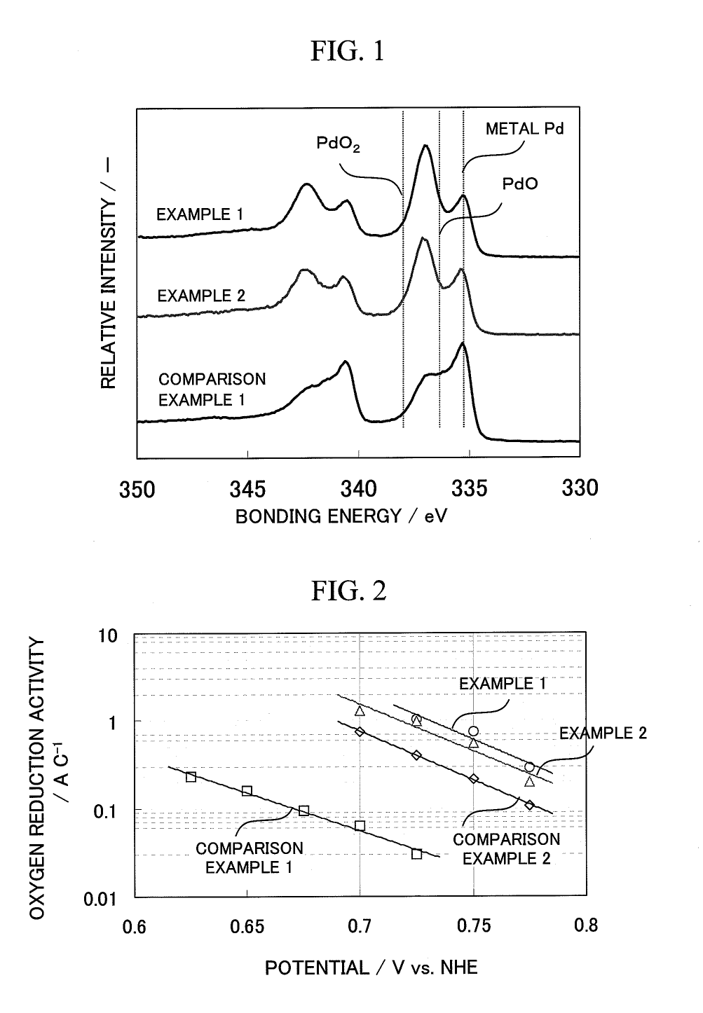

FIG. 1 shows spectra of electrons in the 3d orbital of palladium in the catalysts in Example 1 and Comparison Example 1 measured by XPS analysis. In the drawing the abscissa indicates the bonding energy, and the ordinate indicates the relative intensity.

In this measurement, the X-ray photoelectron spectrometer (AXIS-HS) manufactured by Shimadzu/KRATOS Analytical Ltd. is used.

For the catalyst in Example 1, the peak of the metal palladium (metal Pd) is lower than the other peaks. On the other hand, for the catalyst in Comparison Example 1, the peak of the metal palladium (metal Pd) is higher than the other peaks. For the catalyst in Example 2, although the peak of the metal palladium (metal Pd) is lower than the other peaks, the difference is smaller than that for the catalyst in Example 1. From these facts, it can be seen that the catalysts in Examples 1 and 2 are more highly oxidized than the catalyst in Comparison Example 1, and the catalyst in Example 1 is most highly oxidized.

Table 1 shows the ratios between the metal palladium (metal Pd) and the palladium oxide (PdO, PdO2) calculated by peak analysis of the spectra shown in FIG. 1.

In Example 1, the palladium oxide constitutes 70% of the catalyst. In Example 2, the palladium oxide constitutes 65% of the catalyst. In Comparison Example 1, the palladium oxide constitutes 49% of the catalyst.

### TABLE 1

TABLE 1

| | Metal Palladium (%) | Palladium Oxide (%) |
|---|---|---|
| Example 1 | 30 | 70 |
| Example 2 | 35 | 65 |
| Comparison Example 1 | 51 | 49 |

### (Evaluation 2)

The oxygen reduction activity of the catalysts in Examples 1 and 2 and Comparison Examples 1 and 2 are evaluated.

The evaluation is carried out electrochemically using a rotation disk electrode, and the electronic load device (HZ-3000) manufactured by Hokuto Denko Corporation is used as the evaluation device.

As the rotation disk electrode, the carbon electrode (HR2-D1-GC5) manufactured by Hokuto Denko Corporation is used.

A working electrode is formed on the rotation disk electrode by dropping a solution of pure water containing each catalyst dispersed therein onto the rotation disk electrode, drying the solution under reduced pressure, dropping a solution containing 0.1 weight % of Nafion (registered trademark) on the catalyst, and drying the solution under reduced pressure.

The amount of the catalyst in the working electrode is 0.2 mg/cm2, and the amount of Nafion (registered trademark) is 0.05 mg/cm2.

A platinum wire is used as a counter electrode, and Ag/AgCl (saturated KCl) is used as a reference electrode.

A sulfuric acid aqueous solution having a concentration of 0.5 mol/liter is used as an electrolyte, and the temperature of the electrolyte is set at 35 degrees C.

Prior to the evaluation of the oxygen reduction activity, the amount of electricity for hydrogen desorption is determined by carrying out potential scanning in a range of 0.03 to 1.2 V vs. NHE (normal hydrogen electrode) while bubbling the electrolyte with N2 gas.

Then, potential scanning is carried out in a range of 0.2 to 1.1 V vs. NHE while bubbling the electrolyte with N2 gas, and the measured current is used as a background current.

Then, potential scanning is carried out in a range of 0.2 to 1.1 V vs. NHE while bubbling the electrolyte with O2 gas, and an oxygen reduction current is determined by subtracting the background current from the measured current.

Comparison of the oxygen reduction activity is made in terms of the value of the oxygen reduction current divided by the amount of electricity for hydrogen desorption previously determined. Since the amount of electricity for hydrogen desorption is proportional to the reactive surface area of the catalyst, the oxygen reduction activity is equivalent to the oxygen reduction current per unit reactive surface area.

FIG. 2 shows the oxygen reduction activity of each catalyst. The catalysts in Examples 1 and 2 exhibit higher oxygen reduction activities than the catalysts in Comparison Examples 1 and 2. In FIG. 2, the abscissa indicates the potential, and the ordinate indicates the oxygen reduction activity.

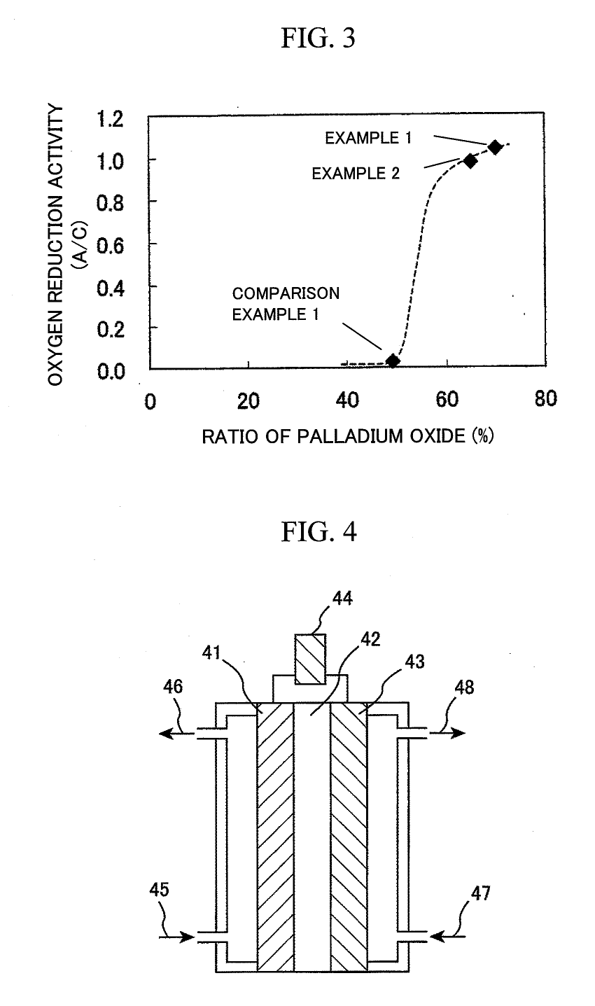

FIG. 3 shows a relationship between the ratios of the palladium oxide in the catalysts in Examples 1 and 2 and Comparison Example 1 and the respective oxygen reduction activities (oxygen reduction currents for a potential of 0.7251 V vs. NHE). The oxygen reduction activity increases when the ratio of the palladium oxide becomes equal to or higher than 50%.

### Example 3

FIG. 4 is a schematic cross-sectional view of a fuel cell according to an embodiment of the present invention.

The fuel cell has an anode 41 containing an anode catalyst and a binder, a cathode 43 containing a cathode catalyst manufactured in this embodiment and a binder, and a solid polymer electrolyte membrane 42 disposed between the anode 41 and the cathode 43. The anode 41, the cathode 43, and the solid polymer electrolyte membrane 42 are collectively referred to as a membrane/electrode assembly.

Although not shown, the anode 41 and the cathode 43 preferably have a diffusion layer, such as carbon paper and carbon cloth.

On the side of the anode 41, a methanol aqueous solution is supplied, and carbon dioxide 46 is discharged. On the side of the cathode 43, an oxidizing gas, such as oxygen and air, is supplied, and an exhaust gas 48 containing the remainder of the introduced oxidizing gas, which has not been used for reaction, and water.

The anode 41 and the cathode 43 are connected to an external circuit 44. In this example, the methanol aqueous solution 45 is used as a fuel. However, alternatively, hydrogen or the like can also be used.

The anode catalyst can be platinum or platinum ruthenium. Carbon-supported platinum or carbon-supported platinum ruthenium is preferably used because fine particles thereof can be easily prepared.

If the solid polymer electrolyte membrane 42 is made of a material having a hydrogen ion conductivity, a stable fuel cell that is not affected by carbonic acid gas in the atmosphere can be provided.

Examples of such a material include sulfonated fluorine-based polymer, such as polyperfluorostyrene sulfonic acid and perfluorocarbon-based sulfonic acid, sulfonated hydrocarbon-based polymer, such as polystyrene sulfonic acid, sulfonated polyether sulfones, sulfonated polyetherether ketones, and alkylsulfonated hydrocarbon-based polymer.

When these materials are used for the electrolyte membrane, in general, the fuel cell can be made to operate at a temperature equal to or lower than 80 degrees C.

Furthermore, the fuel cell can be made to operate at higher temperatures if a composite electrolyte membrane is used that contains a heat-resistant resin or sulfonated resin in which a hydrogen ion conductive inorganic substance, such as tungsten oxide hydrate, zirconium oxide hydrate and tin oxide hydrate, is micro-dispersed.

In particular, composite electrolytes containing sulfonated polyether sulfones, polyetherether sulfones or hydrogen ion conductive inorganic substances are preferably used as the electrolyte membrane, because the permeability of methanol used as the fuel is low compared with polyperfluorocarbon sulfonic acids.

Since an electrolyte membrane having high hydrogen ion conductivity and low methanol permeability increases the utilization of the power generated by the fuel, this example advantageously achieves size reduction of the fuel cell and elongation of the generating time thereof.

As the binder, the same solid polymer electrolytes as those constituting the electrolyte membrane described above can be used.

The membrane/electrode assembly can be manufactured by spraying a solvent containing a catalyst and a binder dispersed therein directly onto an electrolyte membrane, applying the solvent to the electrolyte membrane by an inkjet method or the like, attaching a Teflon sheet with the solvent applied thereto to the electrolyte membrane by thermal transfer, or attaching a diffusion layer with the solvent applied thereto to the electrolyte membrane.

The membrane/electrode assembly or the fuel cell using the cathode catalyst manufactured in this embodiment has a high power density. Furthermore, since platinum is not used in the cathode catalyst, the membrane/electrode assembly and the fuel cell are manufactured at low cost.

### Example 4

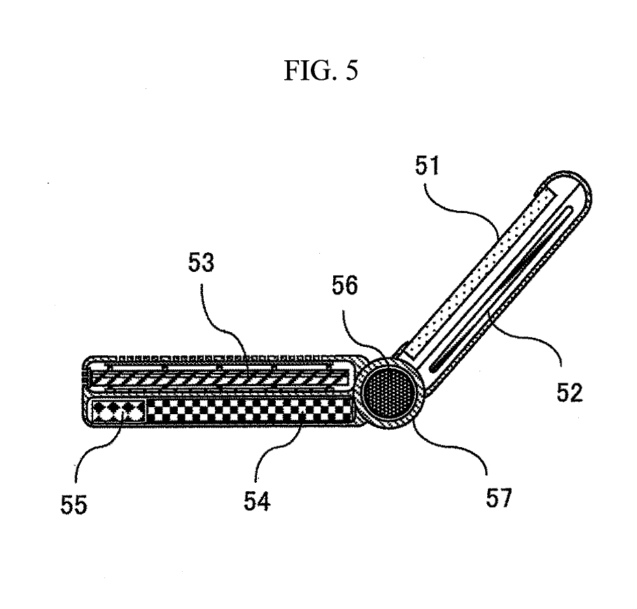

FIG. 5 shows a portable information terminal incorporating the fuel cell manufactured.

The portable information terminal has a part incorporating a display device 51 integrated with a touch-panel input device and an antenna 52.

Furthermore, the portable information terminal has a part incorporating a fuel cell 53, a processor, volatile and nonvolatile memories, a power control section, a hybrid control section for controlling the fuel cell 53 and a lithium ion secondary battery 55, a main board on which an electronic device or circuit, such as a fuel monitor, is mounted, and the lithium ion secondary battery 55. The portable information terminal has a foldable structure with this part coupled to the part described above by a hinge 57, which serves also as a holder for a fuel cartridge 56.

The portable information terminal thus configured can have a light weight and a small size because the fuel cell 53 has a high power density and, therefore, can have a reduced size.

Since the cost of the fuel cell 53 is low, the portable information terminal can also be manufactured at low cost.

According to this example, there can be provided a catalyst for a fuel cell that has high oxygen reduction activity and can be manufactured at low cost, and a fuel cell that has a high power generation efficiency and can be manufactured at low cost.

The fuel cell according to the present invention can be used for portable electric equipment.

What is claimed is:

1. A catalyst for a fuel cell that reduces an oxidizing gas,
wherein the catalyst contains palladium, and said palladium is at least partially oxidized.

2. The catalyst for a fuel cell according to claim 1, wherein at least 50% of said palladium is oxidized.

3. The catalyst for a fuel cell according to claim 1, wherein said palladium is carbon-supported.

4. A fuel cell that has an anode for oxidizing a fuel, a cathode for reducing an oxidizing gas, and a solid polymer electrolyte membrane disposed between said anode and said cathode,
wherein said cathode contains a catalyst for a fuel cell according to claim 1.

5. Portable electric equipment that incorporates a fuel cell according to claim 4.

6. The fuel cell according to claim 4, wherein said fuel is a methanol aqueous solution.

7. The fuel cell according to claim 4, wherein said oxidizing gas is oxygen in the air.
